(19) United States
(12) Patent Application Publication
(10) Pub. No.: US 2026/0243190 A1
(43) Pub. Date: Aug. 20, 2026

(54) RADIATOR CLEANOUT FOR INDUSTRIAL VEHICLE

(71) Applicant: Crown Equipment Corporation, New Bremen, OH (US)

(72) Inventors: Praveen Bennur, Troy, OH (US); Michael Roediger, Rockford, OH (US); Ryan Wilson, Greencastle, IN (US); Robert Chaney, New Bremen, OH (US)

(21) Appl. No.: 19/541,062

(22) Filed: Feb. 16, 2026

Related U.S. Application Data
(60) Provisional application No. 63/759,425, filed on Feb. 17, 2025.

(51) Int. Cl. F01P 11/06; B08B 9/032

(52) U.S. Cl. CPC F01P 11/06; B08B 9/0325; B08B 2209/022; B08B 2209/032; F01P 2011/063

(57) ABSTRACT

A process for cleaning a radiator of an industrial vehicle comprises receiving an indication that an engine of the industrial vehicle has started and then disabling a traction control module of the industrial vehicle. The process overrides an engine speed to increase to a clean-out engine speed regardless of other inputs from an operator and then overrides operation of an engine cooling fan to operate in reverse such that a reverse airflow flows through the radiator. The operation of the engine cooling fan is also dependent on the clean-out engine speed. After a first predetermined amount of time, the engine cooling fan reverts back to normal operation. Based on when the engine cooling fan reverts back to normal operation, the engine reverts back to normal operation and the traction control module is reenabled.

### CROSS REFERENCE TO RELATED APPLICATIONS

This application claims the benefit of U.S. Provisional Patent Application Serial No. 63/759,425 filed February 17, 2025, entitled “RADIATOR CLEANOUT FOR INDUSTRIAL VEHICLE”, the disclosure of which is hereby incorporated by reference.

### BACKGROUND

Various aspects of the present disclosure relate generally to industrial vehicles such as forklifts, tuggers, etc., and more specifically to cleaning a radiator of an industrial vehicle.

Industrial vehicles are used in many types of environments. In some harsher environments, debris and sticky powders (e.g., in a powder-coat booth) may cause radiators and other components to become coated, dirty, or both. As such, when the industrial vehicle is not being used, a technician may manually clean the radiator to avoid engine overheating.

### BRIEF SUMMARY

According to aspects of the present disclosure, a process for cleaning a radiator of an industrial vehicle comprises receiving an indication that an engine of the industrial vehicle has started and then disabling a traction control module of the industrial vehicle. The process overrides an engine speed to increase to a clean-out engine speed regardless of other inputs from an operator and then overrides operation of an engine cooling fan to operate in reverse for a predetermined amount of time, such that a reverse airflow flows through the radiator. The operation of the engine cooling fan is also dependent on the clean-out engine speed. After a first predetermined amount of time, the engine cooling fan reverts back to normal operation. Based on when the engine cooling fan reverts back to normal operation, the engine reverts back to normal operation and the traction control is reenabled.

In some embodiments, a sensor is used to determine whether an engine temperature is below a temperature threshold. If the engine temperature is below the temperature threshold and a second predetermined amount of time has passed, then operation of the engine cooling fan is overridden to operate in reverse such that the reverse airflow flows through the radiator. After a third amount of time, the engine cooling fan is reverted to normal operation. In many of those embodiments, the third predetermined amount of time is identical to the first predetermined amount of time, received from a user via a user interface that sets the third predetermined amount of time, or both. In some embodiments, the second amount of time is received as an input from a user via a user interface, while in other embodiments, an airflow sensor between the radiator and the engine is used to determine an airflow-restriction history of the radiator, and the second amount of time is based on the airflow-restriction history of the radiator.

In various embodiments the process further comprises receiving an input from a user via a user interface that sets the first predetermined amount of time.

In numerous embodiments, a temperature sensor is used to determine a temperature history of the radiator, and the first predetermined amount of time is based on the temperature history.

In several embodiments, an airflow sensor between the radiator and the engine is used to determine an airflow-restriction history of the radiator, and the first predetermined amount of time and the clean-out engine speed are based on the airflow-restriction history.

In many embodiments, an input from a user is received via a user interface that sets the clean-out engine speed.

In some embodiments, the cooling fan is a hydraulic cooling fan controlled by a hydraulic motor; and overriding operation of the engine cooling fan further comprises modifying a directional control valve that controls the hydraulic motor to control the hydraulic motor in reverse, and controlling a hydraulic pump that further controls the hydraulic motor based on the clean-out engine speed.

In many embodiments, the process further comprises determining whether an operation was received from the operator while the hydraulic engine cooling fan is reversed and displaying, if the operation was received, a message instructing the operator to release the operation, and reenabling the traction control module of the industrial vehicle further includes reenabling, if the operation was received, the traction control module of the industrial vehicle only after receiving an indication that the operator released the operation was received. In such embodiments, the operation includes transitioning the industrial vehicle to be in a forward gear, transitioning the industrial vehicle to be in a reverse gear, activating a function of forks associated with the industrial vehicle, or activating an accelerator.

According to several aspects of the present disclosure, a process for cleaning a radiator of an industrial vehicle comprises receiving an indication that an engine of the industrial vehicle has started and then disabling a traction control module of the industrial vehicle. The process overrides an engine speed to increase to a clean-out engine speed regardless of other inputs from an operator and then overrides operation of an engine cooling fan to operate in reverse for a predetermined amount of time, such that a reverse airflow flows through the radiator. The reverse airflow is in a direction opposite of a normal airflow through the radiator, and the reverse airflow is created by modifying a directional control valve that controls a hydraulic motor to control the hydraulic motor in reverse and controlling a hydraulic pump that further controls the hydraulic motor based on the clean-out engine speed. After a first predetermined amount of time, the engine cooling fan reverts back to normal operation. In some embodiments, the first predetermined amount of time is received via a user interface. The override of the engine is reverted to normal operation, and the traction control module of the industrial vehicle is reenabled. Then a sensor is used to determine whether an engine temperature is below a temperature threshold. If after a second predetermined amount of time has passed and if the engine temperature is below the temperature threshold, the process overrides operation of the engine cooling fan to operate in reverse such that the reverse airflow flows through the radiator. In many embodiments, the second predetermined amount of time is received via the user interface. After a third predetermined amount of time, the engine cooling fan reverts back to normal operation.

In many embodiments, the process further comprises determining whether an operation was received from the operator while the hydraulic engine cooling fan is reversed and displaying, if the operation was received, a message instructing the operator to release the operation. In such embodiments, reenabling the traction control module of the industrial vehicle further includes reenabling, if the operation was received, the traction control module of the industrial vehicle only after receiving an indication that the operator released the operation was received. In similar embodiments, the operation may include transitioning the industrial vehicle to be in a forward gear, transitioning the industrial vehicle to be in a reverse gear, activating a function of forks associated with the industrial vehicle, or activating an accelerator pedal.

### BRIEF DESCRIPTION OF THE SEVERAL VIEWS OF THE DRAWINGS

FIG. 1 is a simplified block diagram illustrating an engine cooling fan operation system, according to various aspects of the present disclosure;

FIG. 2 is a simplified block diagram illustrating electrical components of an industrial vehicle, according to various aspects of the present disclosure; and

FIG. 3 is a flow chart illustrating a process for cleaning a radiator on an industrial vehicle, according to various aspects of the present disclosure.

### DETAILED DESCRIPTION

According to aspects of the present disclosure, a process for automatically cleaning a radiator of an industrial vehicle includes running an engine cooling fan in reverse to produce a reverse airflow for the radiator (i.e., opposite direction of normal airflow through the radiator) when an engine of the industrial vehicle has started up. The reverse airflow is used to dislodge debris (including removing sticky powders) so the radiator is not restricted and can efficiently cool the engine without overheating. When performed at startup, a traction control of the industrial vehicle is disabled, so the engine can be brought to a clean-out engine speed (above an idle speed) without affecting operations of the industrial vehicle while allowing the engine cooling fan to run in reverse at higher speeds than when the engine is at idle. Although the engine cooling fan operates independently of the engine, increasing the engine speed to the clean-out engine speed allows a hydraulic pump to increase the flow, which increases the reversed fan speed. The amount of time that the engine cooling fan is reversed is determined by a user depending on an environment that the industrial vehicle is to be used in, where the fan is reversed longer for harsher environments.

Further, the reversal of the engine cooling fan may be performed during operation of the industrial vehicle as well. At a predefined interval, the engine cooling fan reverses to clean the radiator. However, the traction control is not disabled, as the industrial vehicle may be in use and performing an operation during this time. Also, if the cleaning cycle (i.e., the reversal of the engine cooling fan) is scheduled to happen (i.e., the predefined interval expires), then the cleaning cycle may be skipped or delayed if the engine cooling fan is required to keep the engine below a temperature threshold. The interval between cleaning cycles may be set by a user based on the harshness of the environment. Likewise, the cleaning-cycle time (which may be the same or different than the cleaning-cycle time at startup) may be set by a user based on the harshness of the environment.

If the industrial vehicle includes a display, the display may show various messages during the cleaning cycles (e.g., “radiator cleanout”, “traction disabled”, etc.).

The processes described herein have advantages over existing solutions. For example, during the startup cycle cleanout, by disabling the traction control and increasing the engine speed, the engine cooling fan (which is a hydraulic fan) can be controlled to a higher speed than if the engine is idling (as it would be at startup). Further, the cycle time is programmable, which allows the industrial vehicle to have differently timed cleanout cycles depending on the environment. Also, the interval timing is programmable, which allows the industrial vehicle to change timing between cleanout cycles depending on the environment.

### Industrial Vehicle Hydraulics

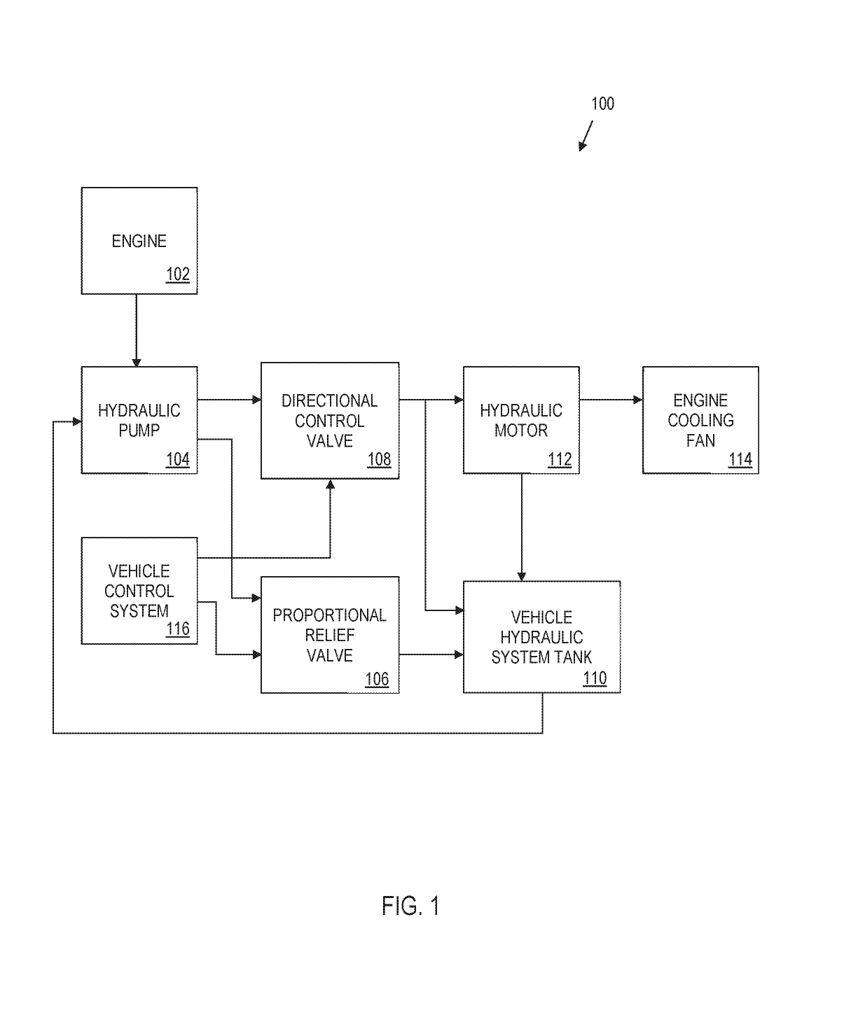

Turning now to FIG. 1, a block diagram of a simplified hydraulic system flow 100 for an industrial vehicle is shown. An engine 102 of the industrial vehicle feeds a hydraulic pump 104, and an engine speed of the engine 102 dictates a maximum pressure that can be supplied by the hydraulic pump 104. In return, the hydraulic pump 104 feeds both a proportional relief valve 106 and a direction control valve 108, both of which feed a vehicle hydraulic system tank 110. The direction control valve 108 also feeds a hydraulic motor 112, which controls an engine cooling fan 114. A vehicle control system 116 controls both the proportional relief valve 106 and the direction control valve 108 to supply the correct pressure to operate the hydraulic motor 112 properly.

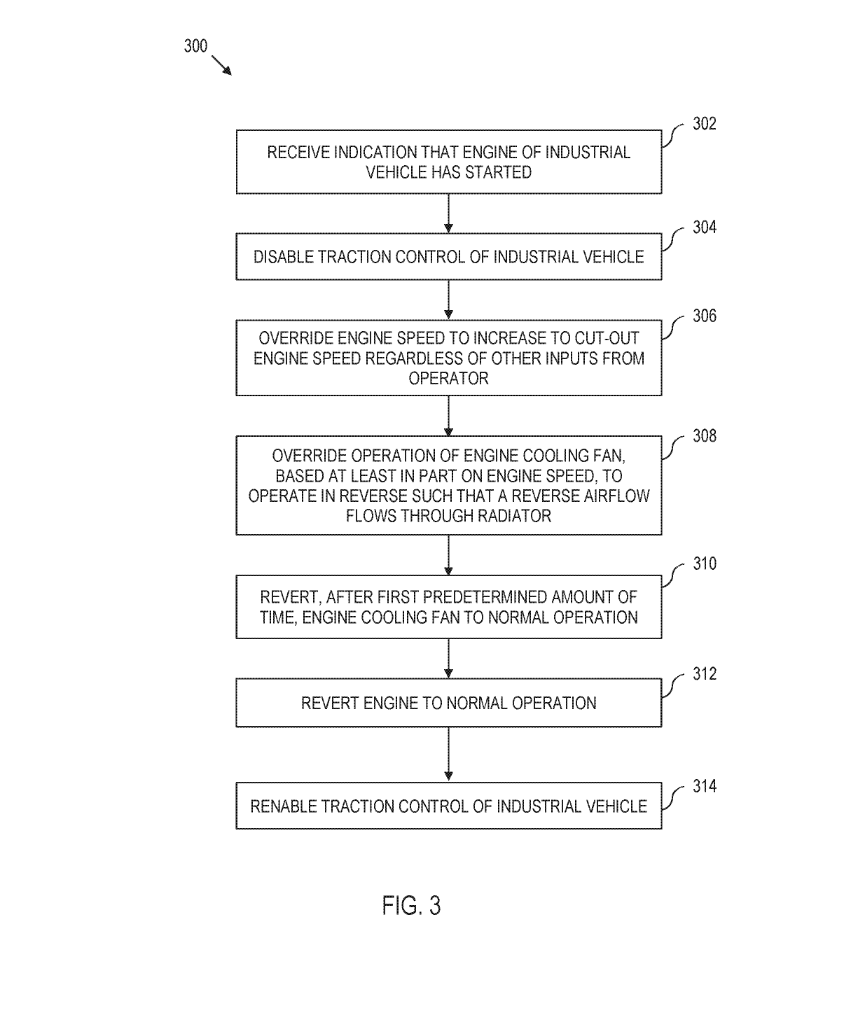

The engine cooling fan 114 (along with a radiator and other devices) is responsible for maintaining an operating temperature of the engine below a certain temperature threshold (e.g., 105 ̊ Celsius) by directing a normal airflow to the engine 102. However, according to aspects of the present disclosure, the engine cooling fan 114 is operable to reverse a direction of the airflow (to create a reverse airflow) to clean a radiator of the industrial vehicle. To do so, the vehicle control system 116 controls the direction control valve 108 to reverse the hydraulic motor 112 that controls the engine cooling fan 114 to reverse and to operate at a speed based on the hydraulic pump 104 (see process 300, FIG. 3). Reverse operation of the engine cooling fan 114 is discussed in greater detail below.

### Industrial Vehicle Electronics

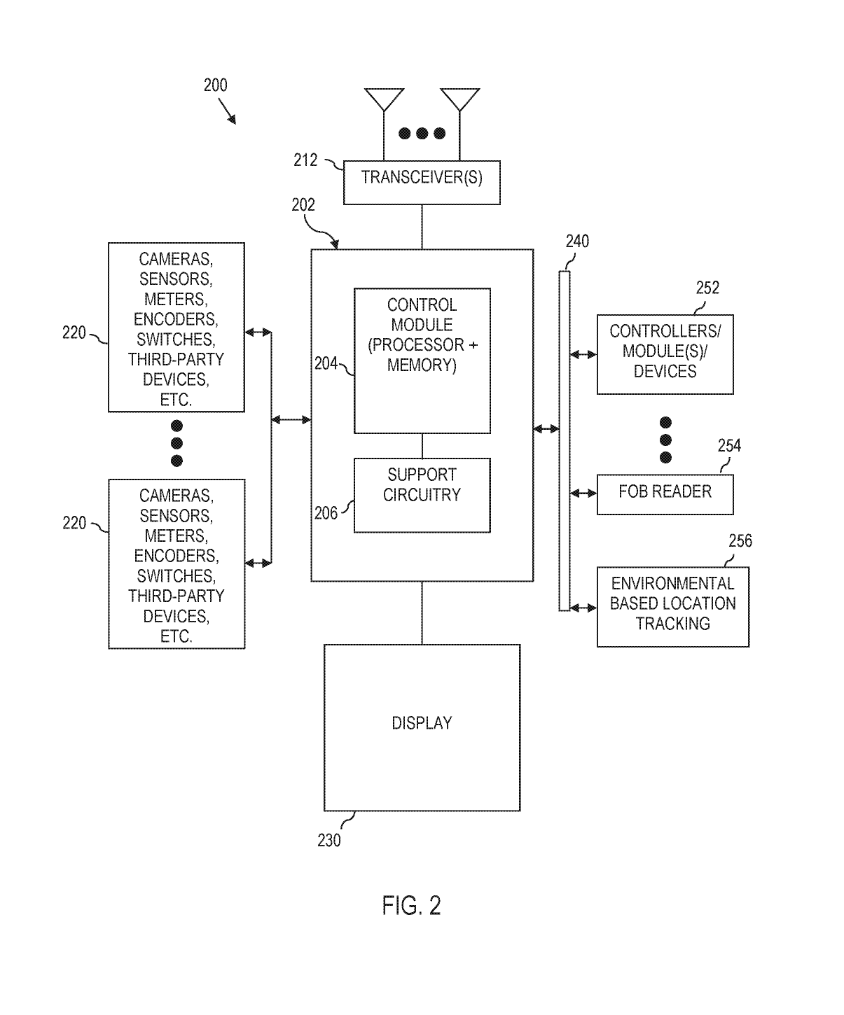

Referring to FIG. 2, a schematic diagram 200 illustrates an exemplary electrical system for an industrial vehicle. The schematic diagram 200 is not intended to be exhaustive. Rather, the schematic diagram is intended to highlight certain features helpful in understanding aspects of the claimed invention.

In particular, a processing device 202 is provided on an industrial vehicle. Here, the processing device 202 is a special purpose, particular hardware computer, such as a device that mounts to or is otherwise integrated with the industrial vehicle.

The illustrated processing device 202 can include a control module 204 (see 116, FIG. 1), support circuitry 206, and other optional circuitry. Moreover, the processing device 202 can be communicably coupled to vehicle circuitry, such as one or more transceivers 212, peripheral device(s) 220, a display(s) 230, interface(s) 240, or combinations thereof.

The control module 204 can include, for instance, one or more processors, memory, controllers, buffers, convertors, other circuitry etc., for carrying out functions of the processing device 202, as described more fully herein. By way of brief introduction, the memory can be used to store vehicle events, configuration data, logged vehicle data, control data, set points, a software client, security code, processing instructions, etc. The processor(s) can be used to collect data, perform computations, perform real-time data processing, implement vehicle functionality, implement a display engine, perform I/O processing, communicate with native vehicle controllers, etc. In this regard the processor(s) and memory of the control module 204 can be used to carry out computer-implemented processes, alone or in combination with other processing devices (on or off the associated materials handling vehicle) as described more fully herein.

The support circuitry 206 provides the circuitry necessary to enable the control module 204 to interact with other features of the industrial vehicle. By way of non-limiting example, the support circuitry 206 can implement interfaces, such as a universal serial bus (USB) interface, controller area network (CAN) interface, other network interface(s), a pogo pin interface etc. The support circuitry 206 can also provide video ports, camera ports, input/output ports (e.g., to interface with a keypad, touchscreen, lights, audible features, haptic features, etc.), additional examples of which are described more fully herein.

The processing device 202 (e.g., via the control module 204) can communicate via one or more transceivers 212, e.g., via Wi-Fi, Bluetooth, ultra-wideband, Zigbee, IrDA, Near Field Communication (NCF), cellular, radio frequency (RF), combinations thereof, etc. Moreover, each transceiver technology can include one or more antenna, e.g., for redundancy, for location/position determination, for reliability, combinations thereof, etc.

The processing device 202 can optionally communicate with various industrial vehicle peripheral devices 220 (e.g., cameras, lasers, sensors (e.g., temperature sensors, airflow sensors, etc.), meters, encoders, light bars, sound/haptic devices, Internet of Things (IoT) devices, scanners, switches, controls, third party devices, vehicle control and/or enabling circuitry (e.g., key switching), microphones, headsets, etc.), e.g., for data logging, hour meter logging, automated control, data monitoring, facilitating communication with electronics external to the processing device 202, etc.

The processing device 202 can also interface with a display 230 to provide glanceable information, to provide messages, to carry out inspection checklists, to facilitate operator login, etc.

In some implementations, the processing device 202 can communicate across one or more native vehicle interfaces 240, e.g., a Controller Area Network (CAN) bus, universal serial bus (USB) interface, I/O interface, Local Interconnect Network (LIN), time-triggered data-bus protocol (TTP) bus, RS422 bus, ethernet bus, etc.

The interface(s) 240 facilitate the processing device 202 communicating with native industrial vehicles features, such as controllers 252 (e.g., hydraulic controller, traction controller, steer controller, or other devices that conventionally communicate across native vehicle interface(s).

The processing device 202 can also communicate, e.g., via an interface 240, with a fob reader 254 (or keypad, card reader or any other device) for receiving operator credentials.

According to yet further aspects of the present disclosure, the processing device 202 can communicate, e.g., via an interface 240, with a location tracking device 256 that is provided on the materials handling vehicle. The location tracking device 256 enables the industrial vehicle to be spatially aware of its location within a local space, e.g., within a warehouse.

Thus, the processing device 202 connects with, understands and is capable of communication with industrial vehicle components, such as peripheral devices, transceivers, displays, controllers, readers, environmental location tracking devices, etc.

The display 230 is any device that can present data that can be visually discerned. By way of nonlimiting example, the display can utilize technology to present data using a liquid crystal display (LCD) screen, Light Emitting Diode (LED) screen; Organic Light Emitting Diode (OLED) screen; a thin-film transistor (TFT) screen; a segment display screen; a graphic display screen; etc.

The display 230 includes a housing having a display section. For instance, in the illustrated example, the display 230 can also optionally include a bezel (e.g., a frame). Moreover, the bezel may support a vehicle operator control section, which can include hardware controls (e.g., one or more navigation buttons, an enter/select button, a power button, one or more encoders (e.g., see optional rotary encoder), etc., in any combination) which allow a user to interact with a user interface displayed on the display 230. In some implementations, the display may include or otherwise support optional user interface features (e.g., a touch screen, inductive screen, proximity sensor, gesture control functionality, etc.). In this regard, program code can enable graphic elements to functionally respond to touch, proximity, gesture controls, etc. In some implementations, program code can be utilized to graphically display a separate/distinct user interface section, e.g., to implement graphically displayed navigation controls, e.g., to augment, duplicate, replace, etc., hardware controls.

### Process for Cleaning a Radiator of an Industrial Vehicle

Turning to FIG. 3, a process 300 for cleaning a radiator of an industrial vehicle is shown and may be performed, at least in part, by the vehicle control system (116, FIG. 1). At 302, an indication that an engine of the industrial vehicle has started is received. For example, many industrial vehicles require an operator to use a key, a fob, a login, etc., or combinations thereof, to start the industrial vehicle.

At 304, a traction control module (see 252, FIG. 2) is disabled, which prevents the industrial vehicle from travelling. At 306, the normal engine control (by the operator) is overridden to increase engine speed (e.g., revolutions per minute) to a clean-out engine speed regardless of any inputs received from the operator at that time. The clean-out engine speed may be programmed by a user (who may be the same or different from the current operator) at an earlier time via a user interface. As indicated above, the user interface may be displayed on the display. In some embodiments, the clean-out engine speed may be determined using temperature sensors, air flow sensors, etc., or combinations thereof, that sense a history of the radiator temperature, airflow, etc., or combinations thereof, to determine whether a stronger airflow is required to help dislodge debris from the radiator (where a stronger airflow may be achieved with a higher engine speed).

As noted above, the engine speed does not necessarily dictate the engine cooling fan speed, but a higher engine speed allows for the hydraulic motor to rotate at a higher speed.

At 308, the engine cooling fan operation is overridden to operate in reverse such that an airflow flows through the radiator, i.e., a reverse airflow. The speed of the engine cooling fan is based in part on the engine speed. Further, normal operation of the engine cooling fan is to cool the engine by providing a normal airflow through the radiator. The overriding operation of the process 300 is to reverse the direction of the engine cooling fan to reverse the airflow through the radiator and to run the engine cooling fan at a speed that is not based on the engine temperature. This reverse airflow through the radiator dislodges debris to clean the radiator, which allows the radiator to cool the engine better during normal operation of the industrial vehicle.

In various embodiments, the cooling fan is a hydraulic cooling fan controlled by a hydraulic motor and overriding operation of the engine cooling fan is done by modifying a directional control valve that controls the hydraulic motor to control the hydraulic motor in reverse and controlling a hydraulic pump that further controls the hydraulic motor based on the engine speed.

A message may be displayed on the display that the engine cooling fan is performing a radiator cleaning cycle, that the traction control is disengaged, or both.

At 310, the engine cooling fan is reverted back to normal operation after a first predetermined amount of time. Similar to the clean-out engine speed, the first predetermined amount of time may be programmed by a user (who may be the same or different from the current operator) at an earlier time via a user interface on the display (or other input device). In some embodiments, the first predetermined amount of time may be determined using temperature sensors, air flow sensors, etc., or combinations thereof, that sense a history of the radiator temperature, airflow, etc., or combinations thereof, to determine whether a stronger airflow is required to help dislodge debris from the radiator (where more debris may be dislodged with a longer cycle time).

At 312, the engine is reverted to normal operation. The amount of time that the engine is overridden may be the same or different (e.g., longer) than the time that the engine cooling fan is overridden. For example, if the engine is overridden and then a short time period passes before the engine cooling fan is overridden, then the engine and engine cooling fan are reverted back to normal operation at the same time, the amount of time that the engine is overridden is longer than the engine cooling fan cycle.

At 314, the traction control module is reenabled. In some embodiments, the process 300 checks to determine whether the operator issued an operation while the engine cooling fan is reversed before reenabling the traction control module. Operations that may affect a delay in reenabling the traction control module include: transitioning the industrial vehicle to be in a forward gear, transitioning the industrial vehicle to be in a reverse gear, activating a function of forks associated with the industrial vehicle, activating an accelerator, etc. If the operator did issue such an operation, a message may be displayed on the display for the operator to release (or undo) the operation and the operation itself is disabled. Then, only after the operation is released will the traction control module be reenabled and the operation be allowed again.

In numerous embodiments, the process 300 further includes performing periodic radiator-cleaning cycles after operation. For example, after a second predetermined amount of time, the operation of the engine cooling fan is overridden to operate in reverse such that the reverse airflow flows through the radiator for a third amount of time. The second and third amounts of time may be programmed by a user (who may be the same or different from the current operator) at an earlier time via a user interface on the display (or other input device). In some embodiments, the second and third amounts of time may be determined using temperature sensors, air flow sensors, etc., or combinations thereof, that sense a history of the radiator temperature, airflow, etc., or combinations thereof, to determine whether a stronger airflow is required to help dislodge debris from the radiator (where more debris may be dislodged with a longer cycle time (i.e., the third predetermined amount of time), with a shorter interval between cleaning cycles (i.e., the second predetermined amount of time), or both). After the third predetermined amount of time, the engine cooling fan reverts back to normal operation.

In many embodiments, one or more periodic radiator-cleaning cycles may be suppressed if the engine temperature is above a temperature threshold (as determined by a sensor), because it is more important to ensure that the engine is operating below the temperature threshold than to clean the radiator.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using a Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A process for cleaning a radiator of an industrial vehicle, the process comprising:
receiving an indication that an engine of the industrial vehicle has started;
disabling a traction control module of the industrial vehicle;
overriding an engine speed to increase to a clean-out engine speed regardless of other inputs from an operator;
overriding operation of a hydraulic engine cooling fan, based at least in part on the clean-out engine speed, to operate in reverse such that a reverse airflow flows through the radiator, wherein the reverse airflow is in a direction opposite of a normal airflow through the radiator and the reverse airflow is created by:
modifying a directional control valve that controls a hydraulic motor to control the hydraulic motor in reverse; and
controlling a hydraulic pump that further controls the hydraulic motor based on the clean-out engine speed;
reverting, after a first predetermined amount of time, the hydraulic engine cooling fan to normal operation, wherein the first predetermined amount of time is received via a user interface;
reverting the override of the engine to normal operation;
reenabling the traction control module of the industrial vehicle;
using a sensor to determine whether an engine temperature is below a temperature threshold;
overriding, after a second predetermined amount of time has passed and if the engine temperature is below the temperature threshold, operation of the engine cooling fan to operate in reverse such that the reverse airflow flows through the radiator, wherein the second predetermined amount of time is received via the user interface; and
reverting, after a third predetermined amount of time, the engine cooling fan to normal operation.

2. The process of claim 1 further comprising:
determining whether an operation was received from the operator while the hydraulic engine cooling fan is reversed; and
displaying, if the operation was received, a message instructing the operator to release the operation;
wherein reenabling the traction control module of the industrial vehicle further includes reenabling, if the operation was received, the traction control module of the industrial vehicle only after receiving an indication that the operator released the operation was received.

3. The process of claim 2, wherein the operation includes transitioning the industrial vehicle to be in a forward gear.

4. The process of claim 2, wherein the operation includes transitioning the industrial vehicle to be in a reverse gear.

5. The process of claim 2, wherein the operation includes activating a function of forks associated with the industrial vehicle.

6. The process of claim 2, wherein the operation includes activating an accelerator pedal.

7. A process for cleaning a radiator of an industrial vehicle, the process comprising:
receiving an indication that an engine of the industrial vehicle has started;
disabling a traction control module of the industrial vehicle;
overriding an engine speed to increase to a clean-out engine speed regardless of other inputs from an operator;
overriding operation of an engine cooling fan, based at least in part on the clean-out engine speed, to operate in reverse such that a reverse airflow flows through the radiator, wherein the reverse airflow is in a direction opposite of a normal airflow through the radiator;
reverting, after a first predetermined amount of time, the engine cooling fan to normal operation;
reverting, based on reverting the engine cooling fan to normal operation, the engine to normal operation; and
reenabling the traction control module of the industrial vehicle.

8. The process of claim 7 further comprising:
using a sensor to determine whether an engine temperature is below a temperature threshold;
overriding, after a second predetermined amount of time has passed and if the engine temperature is below the temperature threshold, operation of the engine cooling fan to operate in reverse such that the reverse airflow flows through the radiator; and
reverting, after a third predetermined amount of time, the engine cooling fan to normal operation.

9. The process of claim 8, wherein the third predetermined amount of time is identical to the first predetermined amount of time.

10. The process of claim 8 further comprising receiving an input from a user via a user interface that sets the third predetermined amount of time.

11. The process of claim 8 further comprising receiving an input from a user via a user interface that sets the second predetermined amount of time.

12. The process of claim 8 further comprising:
using an airflow sensor between the radiator and the engine to determine an airflow-restriction history of the radiator; and
determining the second predetermined amount of time based on the airflow-restriction history.

13. The process of claim 7 further comprising receiving an input from a user via a user interface that sets the first predetermined amount of time.

14. The process of claim 7 further comprising:
using a temperature sensor to determine a temperature history of the radiator; and
determining the first predetermined amount of time based on the temperature history.

15. The process of claim 7 further comprising:
using an airflow sensor between the radiator and the engine to determine an airflow-restriction history of the radiator; and
determining the first predetermined amount of time and determining the clean-out engine speed based on the airflow-restriction history.

16. The process of claim 7 further comprising receiving an input from a user via a user interface that sets the clean-out engine speed.

17. The process of claim 7, wherein:
the cooling fan is a hydraulic cooling fan controlled by a hydraulic motor; and
overriding operation of the engine cooling fan further comprises:
modifying a directional control valve that controls the hydraulic motor to control the hydraulic motor in reverse; and
controlling a hydraulic pump that further controls the hydraulic motor based on the clean-out engine speed.

18. The process of claim 7 further comprising:
determining whether an operation was received from the operator while the hydraulic engine cooling fan is reversed; and
displaying, if the operation was received, a message instructing the operator to release the operation;
wherein reenabling the traction control module of the industrial vehicle further includes reenabling, if the operation was received, the traction control module of the industrial vehicle only after receiving an indication that the operator released the operation was received.

19. The process of claim 18, wherein the operation includes transitioning the industrial vehicle to be in a forward or a reverse gear.

20. The process of claim 18, wherein the operation includes activating a function of forks associated with the industrial vehicle or activating an accelerator of the industrial vehicle.
